(19) United States
(12) Patent Application Publication
(10) Pub. No.: US 2016/0012484 A1
(43) Pub. Date: Jan. 14, 2016

(54) Providing Targeted Advertising Using Local Positioning Technology

(71) Applicant: Bank of America Corporation, Charlotte, NC (US)

(72) Inventors: Carrie Anne Hanson, Charlotte, NC (US); Sharon Scanlon, Manahawkin, NJ (US); Don Cardinal, San Antonio, TX (US); David M. Grigg, Rock Hill, SC (US)

(21) Appl. No.: 14/327,767

(22) Filed: Jul. 10, 2014

(51) Int. Cl. G06Q 30/02; H04W 4/04

(52) U.S. Cl. CPC G06Q 30/0261; H04W 4/04

(57) ABSTRACT

Methods and systems for providing targeted advertising using local positioning technology are presented. In some embodiments, a customer assistance computing platform may receive one or more attributes associated with a beacon signal received by a customer computing device and an identifier associated with the customer computing device. Subsequently, the computing platform may determine an identity of a customer using the customer computing device. The computing platform then may determine a location of the customer using the customer computing device based on the one or more attributes associated with the beacon signal. Thereafter, the computing platform may select, based on the identity of the customer and the location of the customer, advertising content to be presented to the customer using the customer computing device. Then, the computing platform may send the selected advertising content to one or more recipient computing devices.

### BACKGROUND

Aspects of the disclosure relate to computer hardware and software. In particular, one or more aspects of the disclosure generally relate to computer hardware and software for providing targeted advertising using local positioning technology.

Many people are increasingly using mobile devices, such as smart phones, tablet computers, wearable devices (e.g., augmented reality glasses, smart watches, and the like), and other types of personal computing devices and mobile computing devices, for a variety of different purposes. As these devices grow more and more popular, users of such devices increasingly demand greater functionality and convenience from such devices, and various organizations and other business entities in turn may be presented with new opportunities to engage and interact with customers and potential customers via such devices.

Although it may be possible for an organization to provide all sorts of information to its customers and potential customers via their mobile devices, it may still remain difficult to engage and interact with customers and potential customers via such devices at the right time, in the right place, with the right information, and/or in an otherwise contextually-relevant way.

### SUMMARY

Aspects of the disclosure relate to various systems and techniques that provide effective, efficient, scalable, and convenient ways of engaging customers and potential customers in contextually-relevant ways, particularly in ways that involve providing targeted advertising using local positioning technology, such as indoor positioning technology.

In accordance with one or more embodiments, a customer assistance computing platform that includes at least one processor, memory, and a communication interface may receive, via the communication interface, from a customer computing device, one or more attributes associated with a beacon signal received by the customer computing device and an identifier associated with the customer computing device. Subsequently, the customer assistance computing platform may determine an identity of a customer using the customer computing device based on the identifier associated with the customer computing device. The customer assistance computing platform then may determine a location of the customer using the customer computing device based on the one or more attributes associated with the beacon signal received by the customer computing device. Thereafter, the customer assistance computing platform may select, based on the identity of the customer using the customer computing device and based on the location of the customer using the customer computing device, advertising content to be presented to the customer using the customer computing device. Then, the customer assistance computing platform may send, via the communication interface, to one or more recipient computing devices, the selected advertising content.

In some embodiments, the beacon signal received by the customer computing device may be associated with at least one beacon deployed at a banking center. In addition, the one or more attributes associated with the beacon signal received by the customer computing device may, in some instances, include a unique identifier associated with the at least one beacon deployed at the banking center.

In some embodiments, the identifier associated with the customer computing device may include user account information associated with a mobile banking application on the customer computing device. In some instances, the customer assistance computing platform may receive, via the communication interface, from the customer computing device, biometric input information captured by the mobile banking application on the customer computing device. In addition, determining the identity of the customer using the customer computing device may, in some instances, include confirming the identity of the customer using the customer computing device based on the biometric input information captured by the mobile banking application on the customer computing device.

In some embodiments, determining the location of the customer using the customer computing device may include accessing beacon deployment information that maps identifiers for a plurality of beacons to corresponding deployment locations of the plurality of beacons. In some instances, determining the location of the customer using the customer computing device may include determining that the customer using the customer computing device is located in a specific area of the banking center.

In some embodiments, the advertising content to be presented to the customer using the customer computing device may be selected based on customer-specific learned experience data. Additionally or alternatively, the advertising content to be presented to the customer using the customer computing device may be selected based on web history information. Additionally or alternatively, the advertising content to be presented to the customer using the customer computing device may be selected based on transaction history information. Additionally or alternatively, the advertising content to be presented to the customer using the customer computing device may be selected based on customer demographic information. Additionally or alternatively, the advertising content to be presented to the customer using the customer computing device may be selected based on multi-channel activity information.

In some embodiments, prior to sending the selected advertising content to the one or more recipient computing devices, the customer assistance computing platform may select the one or more recipient computing devices from one or more potential recipient computing devices based on the identity of the customer using the customer computing device and based on the location of the customer using the customer computing device. In some instances, the one or more recipient computing devices may include the customer computing device. Additionally or alternatively, the one or more recipient computing devices may include a wall display device at the banking center. Additionally or alternatively, the one or more recipient computing devices may include a public device at the banking center.

In some embodiments, the customer assistance computing platform may update customer history data associated with the customer using the customer computing device. In some instances, updating the customer history data associated with the customer using the customer computing device may include determining an effectiveness level of the selected advertising content sent to the one or more recipient computing devices.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an illustrative operating environment in which various aspects of the disclosure may be implemented in accordance with one or more example embodiments;

FIG. 2 depicts an illustrative block diagram of workstations and servers that may be used to implement the processes and functions of certain aspects of the present disclosure in accordance with one or more example embodiments;

FIG. 3 depicts an illustrative computing environment for providing targeted advertising using local positioning technology in accordance with one or more example embodiments;

FIGS. 4A-4D depict an illustrative event sequence for providing targeted advertising using local positioning technology in accordance with one or more example embodiments;

FIGS. 5-8 depict example graphical user interfaces for providing targeted advertising using local positioning technology in accordance with one or more example embodiments; and

FIG. 9 depicts an illustrative method for providing targeted advertising using local positioning technology in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

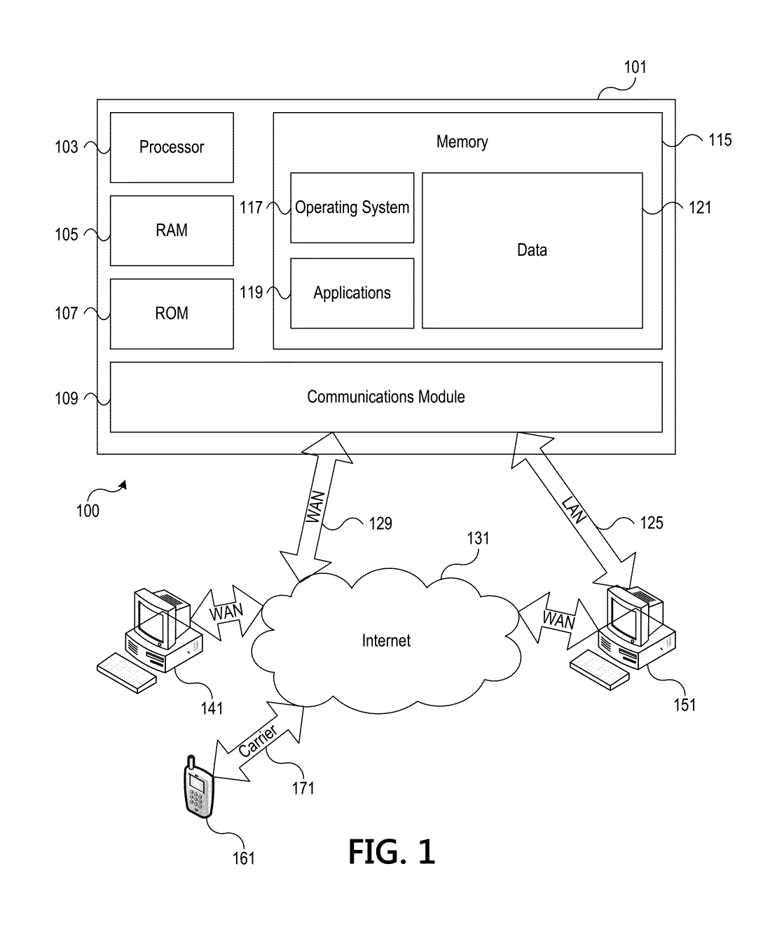

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks), are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141, 151, and 161. Computing devices 141, 151, and 161 may be personal computing devices or servers that include any or all of the elements described above relative to computing device 101. Computing device 161 may be a mobile device (e.g., smart phone) communicating over wireless carrier channel 171.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

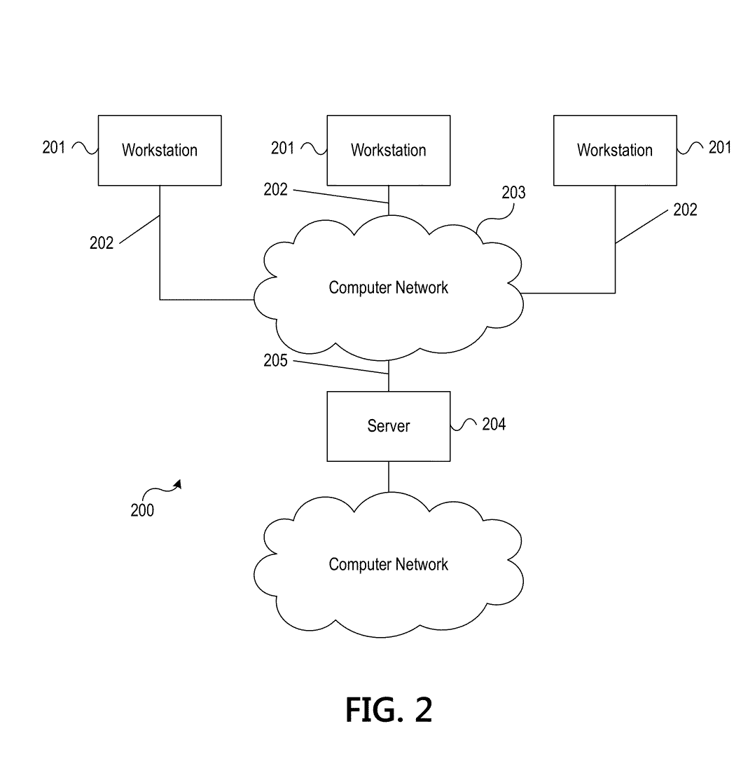

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, as well as network types developed in the future, and the like.

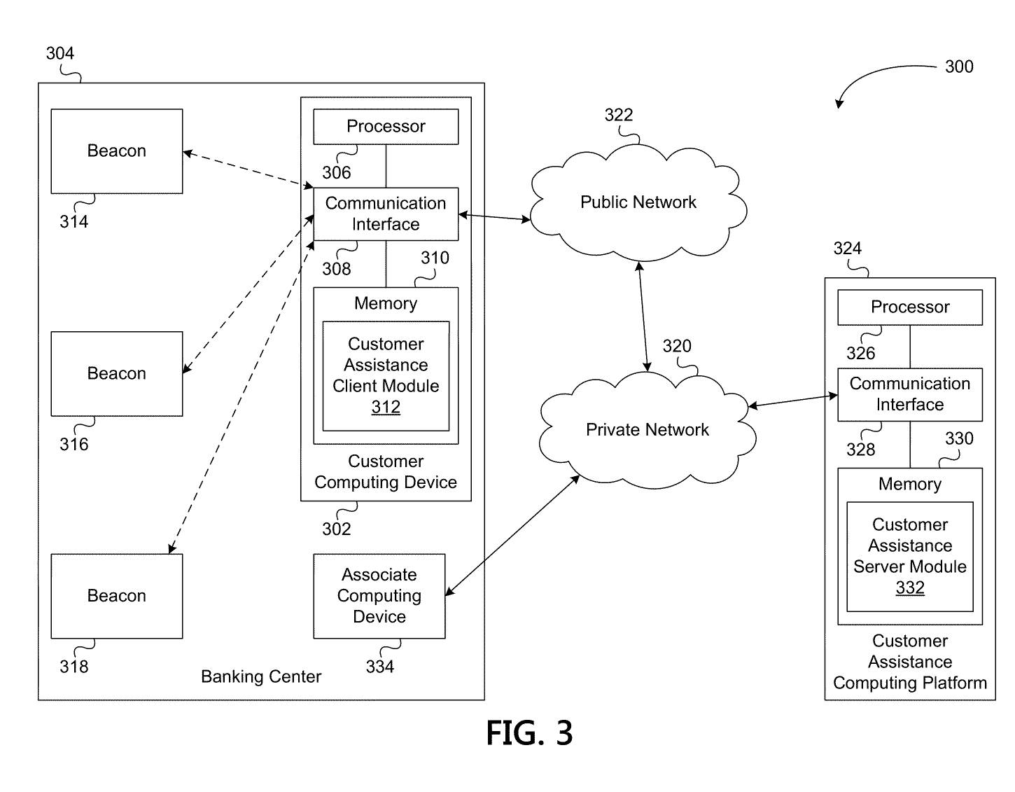

FIG. 3 depicts an illustrative computing environment for providing targeted advertising using local positioning technology in accordance with one or more example embodiments. Referring to FIG. 3, computing environment 300 may include one or more computing devices, such as customer computing device 302. Customer computing device 302 may be any type of computing device capable of receiving a user interface, receiving input via the user interface, and communicating the received input to one or more other computing devices. For example, customer computing device 302 may be a desktop computer, laptop computer, tablet computer, smart phone, or the like. In one or more arrangements, customer computing device 302 may be a personal computing device, such as a mobile computing device (e.g., a smart phone, a tablet computer, a wearable computer, augmented reality glasses, or any other type of mobile device), that belongs to and/or is used by a customer of a financial institution at and/or near a banking center 304 and/or any other location operated by, controlled by, and/or otherwise associated with the financial institution.

Computing environment 300 also may include one or more location beacons, such as location beacon 314, location beacon 316, and location beacon 318. Each location beacon (e.g., location beacon 314, location beacon 316, and location beacon 318) may be configured to transmit one or more radio signals that may be detected and/or received by other devices located in close proximity of and/or otherwise within a predetermined distance of the particular location beacon. In one or more embodiments, any and/or all of the location beacons included in computing environment 300 (e.g., location beacon 314, location beacon 316, and location beacon 318) may implement Bluetooth Low Energy (also referred to as “Bluetooth LE,” “Bluetooth Smart,” or “BLE”) technology to transmit low-power radio signals. The particular signal(s) transmitted by a particular location beacon may include one or more attributes, such as a unique identifier assigned to and/or otherwise associated with the particular location beacon, that may enable the particular location beacon to be identified by a device receiving the particular signal(s) transmitted by the particular location beacon. As illustrated below, by detecting a particular signal transmitted by a location beacon (which may, e.g., be positioned at a specific location) and subsequently identifying the location beacon transmitting the particular signal, a computing device may be able to determine that it located at and/or near the specific location where the location beacon is positioned.

For example, in one or more arrangements discussed below, the one or more location beacons (e.g., location beacon 314, location beacon 316, and location beacon 318) may be positioned at and/or near banking center 304, and may be specifically positioned at and/or near different areas of banking center 304, such as at a welcome area, at a teller counter or window, at a waiting area, at an external alcove where an automated teller machine (ATM) is located, at an external window where drive-up services are provided, at a parking lot, and/or in one or more other distinct areas of banking center 304. In addition, each location beacon may transmit a radio signal that may be detected and/or received by other devices at banking center 304, such as customer computing device 302, which may enable such devices to determine that they are present at banking center 304 and/or located at and/or near a particular area of banking center 304.

In one or more embodiments, customer computing device 302 may include at least one processor 306, communication interface 308, and/or memory 310. A data bus may interconnect processor 306, communication interface 308, and/or memory 310. Memory 310 may include one or more program modules comprising instructions that when executed by processor 306 cause customer computing device 302 to perform one or more functions described herein. For example, memory 310 may include customer assistance client module 312, which may include instructions that when executed by processor 306 cause customer computing device 302 to perform one or more functions described herein. Communication interface 308 may include one or more wired and/or wireless communication interfaces (e.g., network interfaces, radio interfaces, or the like) that are configured to support communication between customer computing device 302 and one or more other devices and/or networks. In one or more arrangements, communication interface 308 may include at least one network interface that facilitates communication between customer computing device 302 and one or more devices and/or networks that are located remotely from banking center 304, and communication interface 308 may further include at least one radio interface that facilitates communication between and/or enables customer computing device 302 to receive wireless radio signals from one or more location beacons (e.g., location beacon 314, location beacon 316, and location beacon 318) and/or other radio transmitters that may be located at and/or near banking center 304.

Computing environment 300 also may include one or more computing platforms. For example, computing environment 300 may include customer assistance computing platform 324. Customer assistance computing platform 324 may include one or more computing devices configured to perform one or more of the functions described herein. For example, customer assistance computing platform 324 may include one or more computers (e.g., laptop computers, desktop computers, servers, server blades, or the like).

Computing environment 300 also may include one or more networks, which may interconnect customer computing device 302, customer assistance computing platform 324, and/or one or more other computing devices. For example, computing environment 300 may include private network 320 and public network 322. Private network 320 and/or public network 322 may include one or more sub-networks (e.g., LANs, WANs, or the like). Private network 320 may be associated with a particular organization (e.g., a corporation, financial institution, educational institution, governmental institution, or the like) and may interconnect one or more computing devices associated with the organization. For example, customer assistance computing platform 324 may be associated with an organization, such as the financial institution that operates, controls, and/or is otherwise associated with banking center 304, and private network 320 may be operated by and/or otherwise associated with the organization, and may include one or more networks (e.g., LANs, WANs, VPNs, or the like) that interconnect customer assistance computing platform 324 and one or more other computing devices associated with the organization. Public network 322 may connect private network 320 and/or one or more computing devices connected thereto (e.g., customer assistance computing platform 324) with one or more networks and/or computing devices that are not associated with the organization. For example, customer computing device 302 might not be associated with the organization that operates and/or is associated with private network 320, and public network 322 may include one or more networks (e.g., the Internet) that connect customer computing device 302 to private network 320 and/or one or more computing devices connected thereto (e.g., customer assistance computing platform 324).

Customer assistance computing platform 324 may include at least one processor 326, communication interface 328, and/or memory 330. Memory 330 may include one or more program modules comprising instructions that when executed by processor 326 cause customer assistance computing platform 324 to perform one or more functions described herein. For example, memory 330 may include customer assistance server module 332, which may include instructions that when executed by processor 326 cause customer assistance computing platform 324 to perform one or more functions described herein. Communication interface 328 may include one or more wired and/or wireless communication interfaces (e.g., network interfaces, radio interfaces, or the like) that are configured to support communication between customer assistance computing platform 324 and one or more other devices and/or networks. For example, communication interface 328 may include at least one network interface that facilitates communication between customer assistance computing platform 324 and one or more other devices and/or networks (e.g., private network 320, public network 322, customer computing device 302, and/or other devices and networks).

Computing environment 300 also may include a banking center associate computing device 334. Banking center associate computing device 334 may include one or more processors, memories, and/or communication interfaces, similar to those that may be included in customer computing device 302. In some instances, banking center associate computing device 334 may be used by an associate, employee, or agent of an organization that may operate the banking center 304, such as the financial institution that may operate the banking center 304, and/or may be used by any other individual associated with such the organization. Banking center associate computing device 334 may be configured to connect to private network 320 and/or may communicate with customer assistance computing platform 324 via private network 320 and one or more communication interfaces. Additionally or alternatively, banking center associate computing device 334 may be configured to connect to public network 322 and/or may communicate with one or more computing devices via public network 322 and one or more communication interfaces. In some instances, multiple banking center associate computing devices, each being similar to banking center associate computing device 334, may be present at a particular banking center, such as banking center 304, even though only one such banking center associate computing device is illustrated in the example depicted in FIG. 3. Similarly, multiple customer computing devices, each being similar to customer computing device 302, may be present at a particular banking center, such as banking center 304, even though only one such customer computing device is illustrated in the example depicted in FIG. 3. Additionally or alternatively, a particular banking center, such as banking center 304, may have any number of beacons, each being similar to beacons 314, 316, and 318, even though three such beacons are illustrated in the example depicted in FIG. 3.

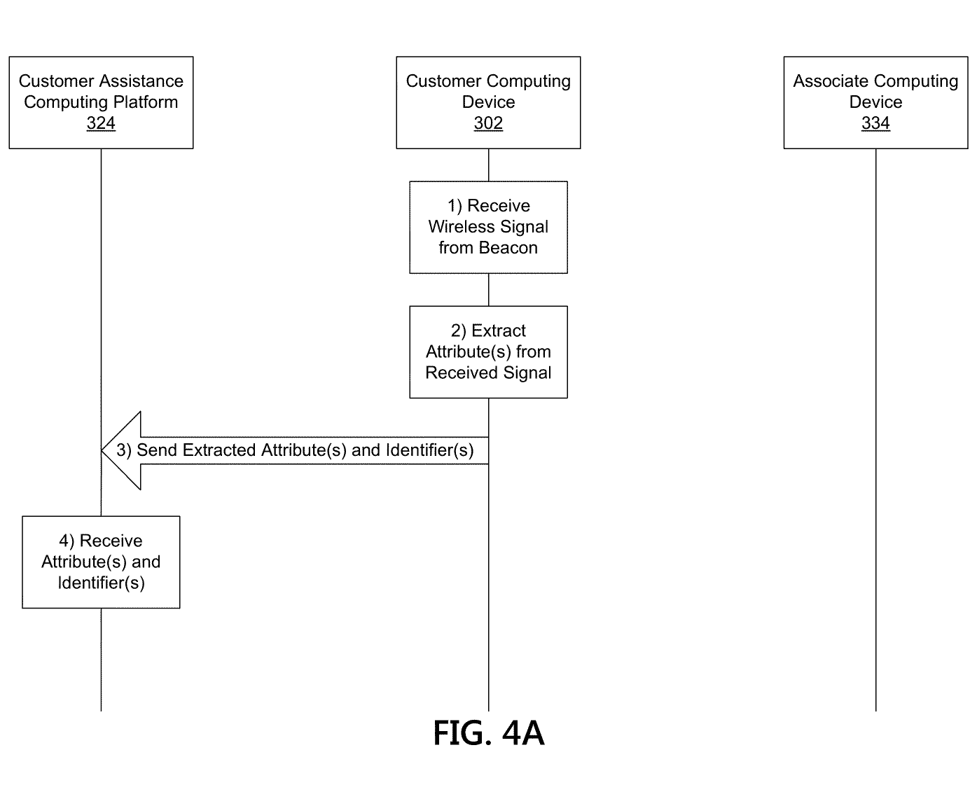

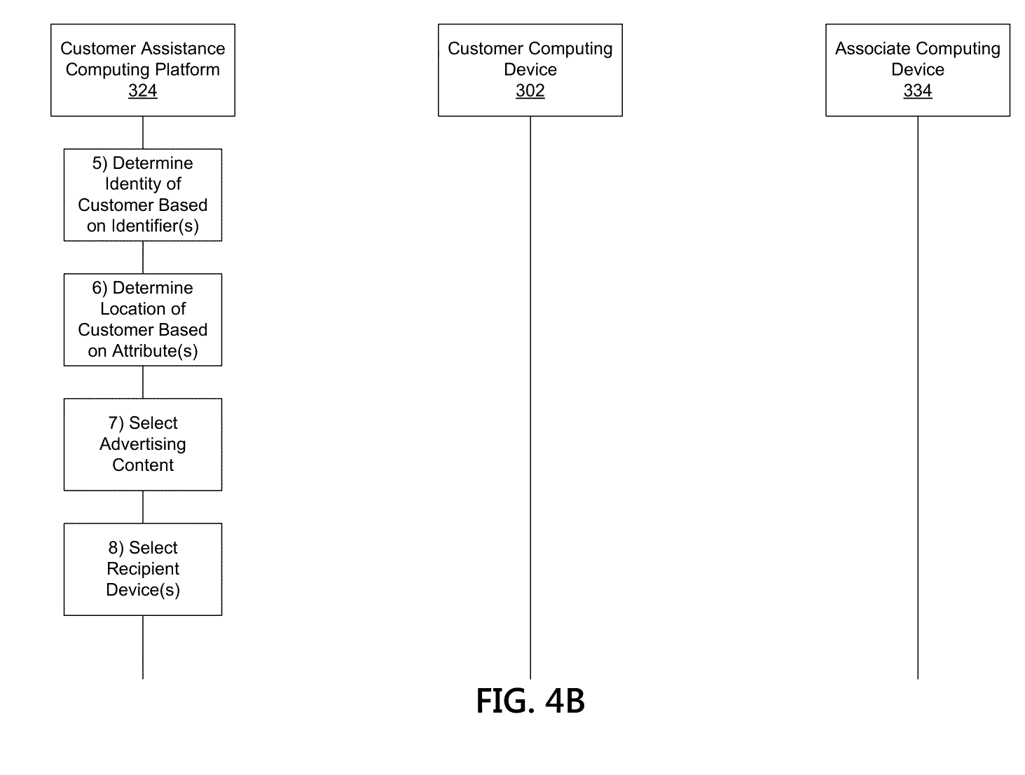

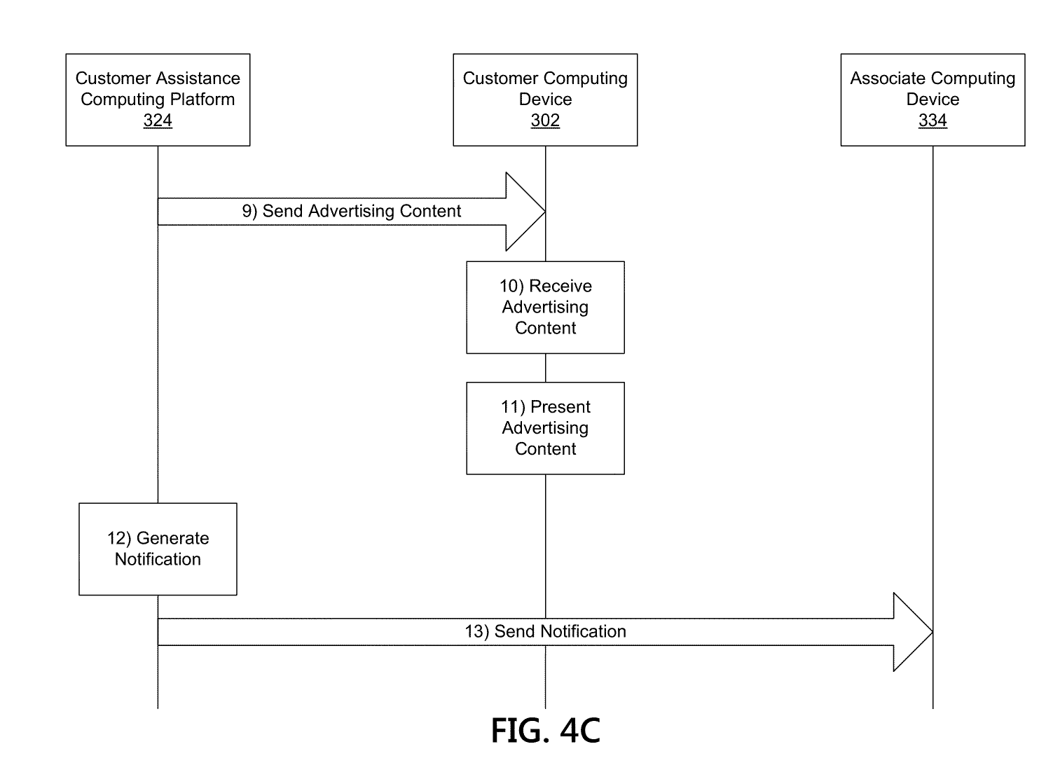

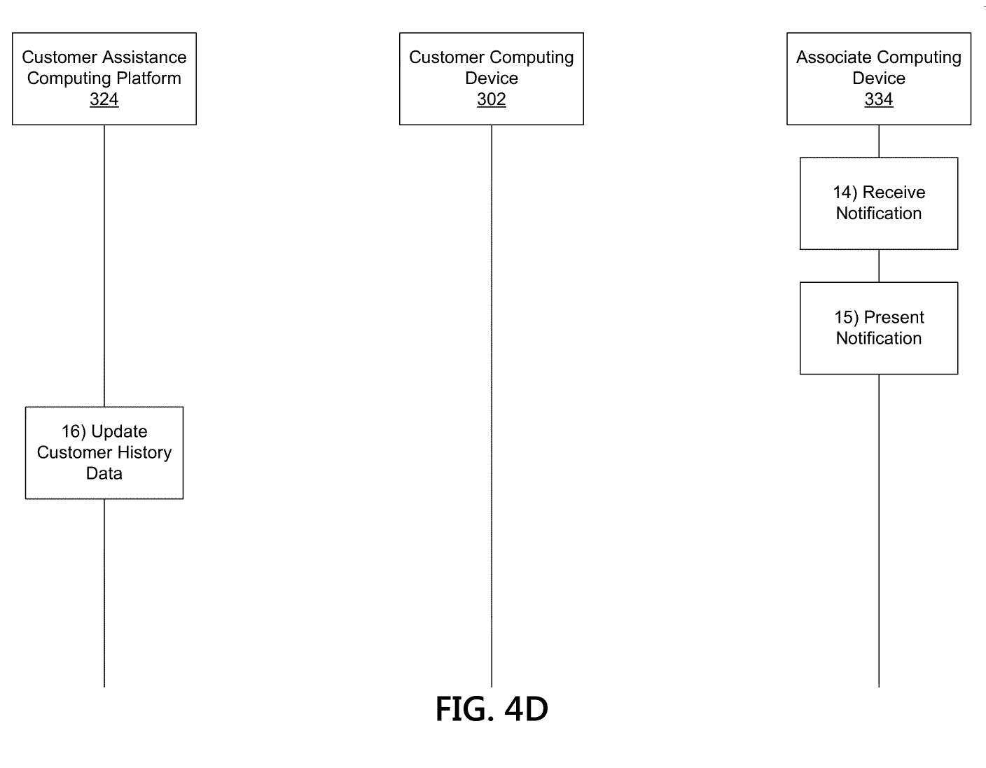

FIGS. 4A-4D depict an illustrative event sequence for providing targeted advertising using local positioning technology in accordance with one or more example embodiments. Referring to FIG. 4A, at step 1, customer computing device 302 may receive a wireless signal from a location beacon. For example, customer computing device 302 may receive such a wireless signal from one or more of beacon 314, beacon 316, and/or beacon 318. Such a wireless signal, which also may be referred to as a “beacon signal,” may be received when (and/or just before and/or after) a user of customer computing device 302 arrives at, enters, and/or otherwise visits banking center 304 (or any other location where the location beacon(s) may be deployed). Thus, the beacon signal received by the customer computing device may, in some instances, be associated with at least one beacon deployed at a banking center, such as banking center 304.

At step 2, customer computing device 302 may extract one or more attributes from the wireless signal received from the location beacon. For example, in extracting one or more attributes from the beacon signal, customer computing device 302 may identify and/or otherwise determine a unique identifier assigned to and/or otherwise associated with the particular location beacon from which the beacon signal was received. If, for instance, a location beacon is deployed at a banking center, such as banking center 304, the one or more attributes associated with the beacon signal received by the customer computing device may include a unique identifier associated with the location beacon deployed at the banking center. Additionally or alternatively, in extracting one or more attributes from the beacon signal, customer computing device 302 may identify and/or otherwise determine one or more other attributes associated with the beacon signal, such as a frequency of the beacon signal, an amplitude of the beacon signal, a round trip time (RTT) value and/or a round trip delay (RTD) value for the beacon signal, an estimated range to the location beacon transmitting the beacon signal, and/or the like.

At step 3, customer computing device 302 may send, to customer assistance computing platform 324, the one or more attributes associated with the beacon signal and/or one or more identifiers associated with customer computing device 302. For example, customer computing device 302 may send, to customer assistance computing platform 324, any and/or all of the attributes extracted from the beacon signal. Additionally or alternatively, customer computing device 302 may send, to customer assistance computing platform 324, information that includes one or more identifiers that are assigned to customer computing device 302, one or more software applications running on customer computing device 302, one or more users of and/or user accounts associated with customer computing device 302, and/or one or more other identifiers that are otherwise associated with customer computing device 302. For instance, customer computing device 302 may send, to customer assistance computing platform 324, an identifier and/or other data that is linked to, and can be used by customer assistance computing platform 324 to identify, customer computing device 302. Additionally or alternatively, customer computing device 302 may send, to customer assistance computing platform 324, an identifier and/or other data that is linked to, and can be used by customer assistance computing platform 324 to identify, a user of customer computing device 302 (e.g., login information entered by the user of customer computing device 302 to access and/or use one or more functions provided by customer computing device 302, a username associated with the user of customer computing device 302 and used in accessing a mobile banking application and/or a mobile banking website on customer computing device 302, and/or other information).

At step 4, customer assistance computing platform 324 may receive the one or more attributes and/or the one or more identifiers from customer computing device 302. For example, customer assistance computing platform 324 may receive, via communication interface 328, from customer computing device 302, the one or more attributes associated with the beacon signal received by customer computing device 302 and one or more identifiers associated with customer computing device 302. In some embodiments, the one or more identifiers associated with the customer computing device may include user account information associated with a mobile banking application on the customer computing device. For example, at least one identifier of the one or more identifiers that may be received by customer assistance computing platform 324 from customer computing device 302 at step 4 may include user account information associated with a mobile banking application installed on, running on, and/or otherwise associated with customer computing device 302. Such user account information may, for example, include a username, password, account number, and/or other user-specific information that may be used in accessing various functions of the mobile banking application and/or a mobile banking website (which may, e.g., be provided by the financial institution operating banking center 304).

In some instances, in addition to receiving one or more attributes associated with a beacon signal and at least one identifier from customer computing device 302, customer assistance computing platform 324 also may receive biometric input information from customer computing device 302. Such biometric input information may, for instance, be captured by a mobile banking application installed on, running on, and/or otherwise associated with customer computing device 302. For example, at and/or after step 4, customer assistance computing platform 324 may receive, via communication interface 328, from customer computing device 302, biometric input information captured by a mobile banking application on the customer computing device. The biometric input information received by customer assistance computing platform 324 from customer computing device 302 may, for example, include information associated with one or more fingerprints, retina scans, voiceprints, facial images, and/or other biometrics associated with the user of customer computing device 302.

At step 5, customer assistance computing platform 324 may determine the identity of a customer based on the one or more identifiers received from customer computing device 302. For example, customer assistance computing platform 324 may determine an identity of a customer using customer computing device 302 based on the identifier associated with the customer computing device (which may, e.g., have been received at step 4). In instances in which customer computing device 302 also sent, and customer assistance computing platform 324 received, biometric input information, customer assistance computing platform 324 may use the received biometric input information in identifying and/or authenticating the customer using customer computing device 302. For example, in determining the identity of the customer using customer computing device 302 in such instances, customer assistance computing platform 324 may confirm the identity of the customer using customer computing device 302 based on the biometric input information (which may, e.g., have been captured by the mobile banking application on the customer computing device).

At step 6, customer assistance computing platform 324 may determine the location of the customer based on the one or more attributes received from customer computing device 302. For example, customer assistance computing platform 324 may determine a location of the customer using customer computing device 302 based on the one or more attributes associated with the beacon signal received by customer computing device 302. In one or more embodiments, the location of the customer using the customer computing device may be determined based on information identifying the known deployment location of the location beacon from which the customer computing device received the beacon signal. In some embodiments, determining the location of the customer using the customer computing device may thus include accessing beacon deployment information that maps identifiers for a plurality of location beacons to corresponding deployment locations of the plurality of location beacons. The deployment locations of the plurality of location beacons (which may, e.g., be mapped in the beacon deployment information) may, for example, include two or more different banking centers that are operated by the financial institution, specific areas of various banking centers operated by the financial institution, and/or other areas associated with the financial institution.

In some embodiments, determining the location of the customer using the customer computing device may include determining that the customer using the customer computing device is located in a specific area of a banking center, such as banking center 304. For example, in addition to determining that the customer using customer computing device 302 is located at and/or near a particular banking center, such as banking center 304, customer assistance computing platform 324 may determine that the customer using customer computing device 302 is located in a particular area of the banking center, such as in the main lobby of the banking center, in a teller line, in a waiting area, in or outside of a particular office, in an automated teller machine (ATM) vestibule, in a parking lot outside of the banking center, at an external ATM outside of the banking center, in a particular drive-up service lane outside of the banking center, and/or the like.

At step 7, customer assistance computing platform 324 may select advertising content to be presented based on the determined identity of the customer using customer computing device 302 and/or based on the determined location of customer of the customer using customer computing device 302. For example, at step 7, customer assistance computing platform 324 may select, based on the identity of the customer using customer computing device 302 and based on the location of the customer using customer computing device 302, advertising content to be presented to the customer using customer computing device 302. Such advertising content may, for example, be selected by customer assistance computing platform 324 from a library of available advertising content that is maintained by and/or accessible to customer assistance computing platform 324. In some instances, the selected advertising content may relate to products and/or services offered by the financial institution operating the banking center (e.g., banking center 304). In other instances, the selected advertising content may relate to products and/or services offered by an organization or other entity different from the financial institution operating the banking center (e.g., banking center 304).

In some embodiments, the advertising content to be presented to the customer using the customer computing device may be selected based on customer-specific learned experience data. For example, customer assistance computing platform 324 may select advertising content to be presented to the customer using customer computing device 302 based on learned experience data that is specific to and/or otherwise associated with the customer using customer computing device 302. Such learned experience data may, for example, include information about one or more reasons for which the customer has previously visiting the banking center (e.g., banking center 304); information about the customer's previous, current, and/or future appointments at the banking center; information about one or more transactions that the customer has previously completed at the banking center; and/or other information.

In some embodiments, the advertising content to be presented to the customer using the customer computing device may be selected based on web history information. For example, customer assistance computing platform 324 may select advertising content to be presented to the customer using customer computing device 302 based on web history information that is specific to and/or otherwise associated with the customer using customer computing device 302. Such web history information may, for example, include information describing the customer's previous interaction(s) with an online banking website, a mobile banking interface, web browsing and/or search history, and/or other information.

In some embodiments, the advertising content to be presented to the customer using the customer computing device may be selected based on transaction history information. For example, customer assistance computing platform 324 may select advertising content to be presented to the customer using customer computing device 302 based on transaction history information that is specific to and/or otherwise associated with the customer using customer computing device 302. Such transaction history information may, for example, include information describing one or more transactions that the customer has completed using his or her checking account, savings account, and/or other accounts that the customer may maintain with the financial institution operating the banking center (e.g., banking center 304).

In some embodiments, the advertising content to be presented to the customer using the customer computing device may be selected based on customer demographic information. For example, customer assistance computing platform 324 may select advertising content to be presented to the customer using customer computing device 302 based on demographic information that is specific to and/or otherwise associated with the customer using customer computing device 302. Such customer demographic information may, for example, include information about the customer's age, gender, region, and/or other demographic information (which may, e.g., be maintained by customer assistance computing platform 324 and/or accessible to customer assistance computing platform 324 via one or more other computer systems operated by and/or otherwise associated the financial institution operating the banking center).

In some embodiments, the advertising content to be presented to the customer using the customer computing device may be selected based on multi-channel activity information. For example, customer assistance computing platform 324 may select advertising content to be presented to the customer using customer computing device 302 based on multi-channel activity information that is specific to and/or otherwise associated with the customer using customer computing device 302. Such multi-channel activity information may, for example, include information describing the customer's activity across one or more different channels that may be provided by the financial institution operating the banking center (e.g., banking center 304). The one or more different channels may, for instance, include an online banking channel, a mobile banking channel, an in-person banking channel, and/or one or more other channels.

At step 8, customer assistance computing platform 324 may select one or more recipient devices to receive the advertising content to be presented to the customer using customer computing device 302. For example, at step 8, customer assistance computing platform 324 may select one or more recipient computing devices from one or more potential recipient computing devices, and the one or more recipient computing devices may be selected based on the identity of the customer using customer computing device 302 (e.g., as determined at step 5) and/or based on the location of the customer using customer computing device 302 (e.g., as determined at step 6). In selecting the one or more recipient computing devices to receive the advertising content, customer assistance computing platform 324 may take into account both the identity of the customer using customer computing device 302 (e.g., as the customer may have specific user preferences related to how advertising content may be presented to the customer) and the location of the customer using customer computing device 302 (e.g., as the customer's location may inform not only the particular advertising content that is contextually relevant to the customer but also may inform the way(s) in which such advertising content is presented to the customer, such as via one or more physically fixed display devices and/or via other means). For example, a particular customer may have set user preferences dictating that advertising content not be displayed on his or her personal device, and so, in selecting one or more recipient computing devices to receive advertising content to be presented to the customer, customer assistance computing platform 324 may select a wall display device or a public computing device located near (e.g., within a determined distance of) the customer, rather than selecting the customer's personal device as a recipient computing device for the advertising content.

At step 9, customer assistance computing platform 324 may send, to customer computing device 302 and/or one or more other recipient computing devices, the advertising content to be presented to the customer using customer computing device 302. For example, at step 9, customer assistance computing platform 324 may send, via communication interface 328, to one or more recipient computing devices, the selected advertising content (e.g., as selected at step 7). In some instances, the one or more recipient computing devices may include the customer computing device (e.g., customer computing device 302), while in other instances, the one or more recipient computing devices might not include the customer computing device. Additionally or alternatively, in some instances, the one or more recipient computing devices may include a wall display device at the banking center, such as a wall-mounted video display device located at banking center 304, a floor-mounted video display device located at banking center 304, a window-mounted video display device located at banking center 304, and/or another physical display device located at banking center 304. For example, customer assistance computing platform 324 may send the selected advertising content to a wall-mounted video display board that is located in the lobby of banking center 304 within a predetermined distance of the previously-determined location of the customer using customer computing device 302. Additionally or alternatively, the one or more recipient computing devices may include a public device at the banking center, such as a tablet computer provided for shared use by various customers visiting banking center 304 (and which may, e.g., be used by such customers while they are waiting in a teller line or waiting area of banking center 304).

At step 10, customer computing device 302 may receive advertising content from customer assistance computing platform 324. For example, at step 10, customer computing device 302 may receive from customer assistance computing platform 324 the advertising content selected by customer assistance computing platform 324 (e.g., at step 7) and sent by customer assistance computing platform 324 (e.g., at step 9). At step 11, customer computing device 302 may present one or more advertisements based on the advertising content received from customer assistance computing platform 324.

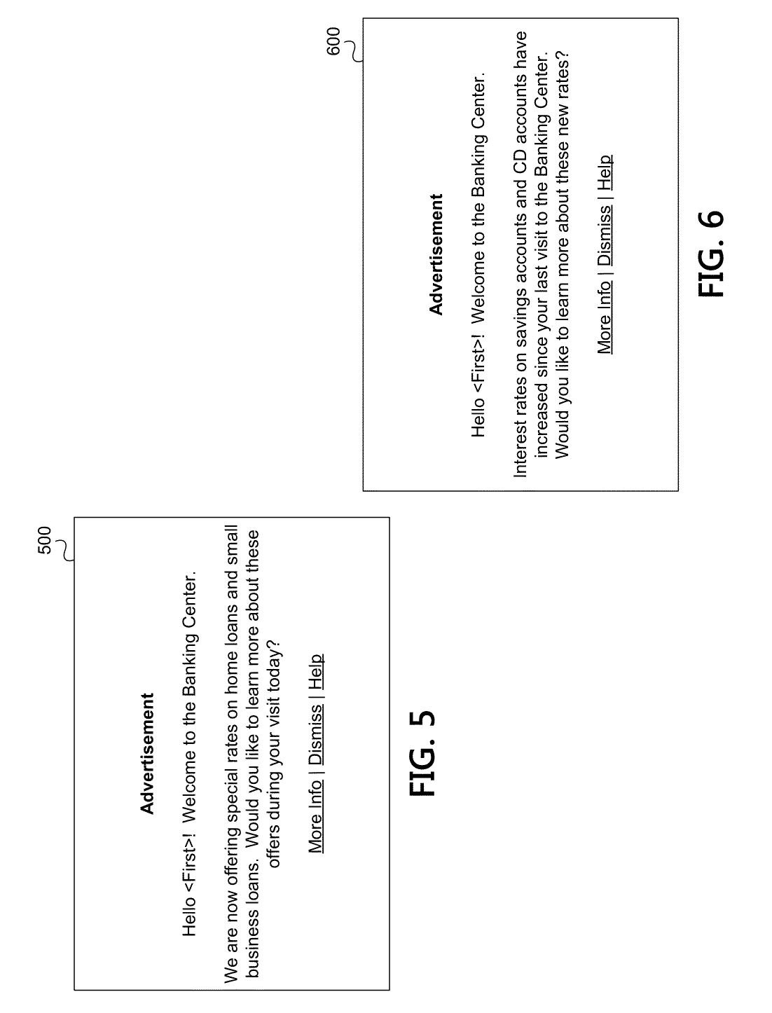

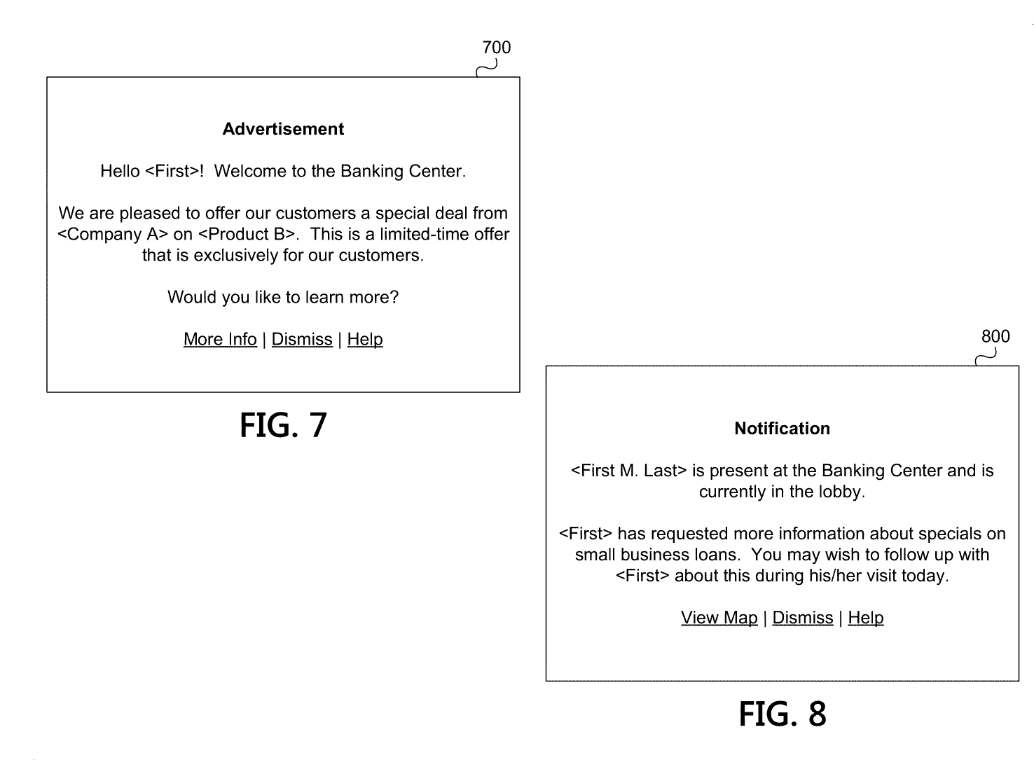

In presenting one or more advertisements, customer computing device 302 may, for example, display, cause to be displayed, and/or otherwise present a graphical user interface similar to graphical user interface 500, as seen in FIG. 5, and/or graphical user interface 600, as seen in FIG. 6, and/or graphical user interface 700, as seen in FIG. 7. In the example illustrated in FIG. 5, the user of customer computing device 302 may be presented with advertising content related to special rates on home loans and small business loans, and such advertising content may have been selected for the customer using customer computing device 302 by customer assistance computing platform 324, for instance, based on the customer's web history information indicating that the customer has been researching such products via an online banking interface. In the example illustrated in FIG. 6, the user of customer computing device 302 may be presented with advertising content related to changes in interest rates, and such advertising content may have been selected for the customer using customer computing device 302 by customer assistance computing platform 324, for instance, based on learned experience data indicating that the customer has visited the banking center on one or more previous occasions to learn more about and/or otherwise discuss interest rates, savings accounts, certificates of deposits, and/or the like. In the example illustrated in FIG. 7, the user of customer computing device 302 may be presented with advertising content related to products and/or services offered by a third-party organization or other entity different from the financial institution operating banking center 304, and such advertising content may have been selected for the customer using customer computing device 302 by customer assistance computing platform 324, for instance, based on customer demographic information.

Referring to FIG. 4C, at step 12, customer assistance computing platform 324 may generate a notification indicating that advertising content has been sent to the customer using customer computing device 302. Such a notification may, for example, identify the particular advertising content that was sent, the current location of the customer using customer computing device 302, and/or other information. At step 13, customer assistance computing platform 324 may send the notification (e.g., as generated at step 12) to associate computing device 334. At step 14, associate computing device 334 may receive the notification from customer assistance computing platform 324, and at step 15, associate computing device 334 may present the notification received from customer assistance computing platform 324. Such a notification may, for example, enable one or more banking center associates (who may, e.g., be using banking center associate computing device 334 at the banking center at which the customer using customer computing device 302 is located) to be aware of the customer's presence, personally greet the customer, follow up with the customer about the advertising content, respond to any questions the customer may have about the advertising content, and/or otherwise engage with the customer in a personalized and/or relevant way. In presenting such a notification, associate computing device 334 may, for example, display, cause to be displayed, and/or otherwise present a graphical user interface similar to graphical user interface 800, as seen in FIG. 8. For instance, graphical user interface 800 may include information indicating that the customer using customer computing device 302 is present at banking center 304 and has requested information about one or more specific products, which may enable a banking center associate using associate computing device 334 to follow up with the customer about the one or more specific products and/or otherwise engage with the customer using customer computing device 302 in a contextually relevant way.

Referring to FIG. 4D, at step 16, customer assistance computing platform 324 may update customer history data. For example, at step 16, customer assistance computing platform 324 may update customer history data associated with the customer using customer computing device 302. In updating such customer history data, customer assistance computing platform 324 may, for instance, create and/or modify one or more records indicating that specific advertising content (e.g., the advertising content selected by customer assistance computing platform 324 at step 7 and/or sent to one or more recipient devices at step 9) was presented to the customer using customer computing device 302 at a specific time, on a specific day, in a specific location, and/or the like.

In some embodiments, updating the customer history data associated with the customer using the customer computing device may include determining an effectiveness level of the selected advertising content sent to the one or more recipient computing devices. For example, in updating the customer history data associated with the customer using customer computing device 302, customer assistance computing platform 324 may determine an effectiveness level of the advertising content that was sent to the one or more recipient devices.

In determining such an effectiveness level, customer assistance computing platform 324 may, for example, determine if the customer using customer computing device 302 subsequently purchased and/or used a product and/or service related to the advertising content, and/or customer assistance computing platform 324 may update effectiveness data associated with the specific advertising content accordingly. Such effectiveness data may, for example, be used by customer assistance computing platform 324 in the future in prioritizing and/or selective advertising content to be presented to the customer using customer computing device 302 and/or to one or more other customers (who may, e.g., have similar characteristics as the customer using customer computing device 302). In some instances, customer assistance computing platform 324 may automatically determine an effectiveness level of the advertising content when a predetermined amount elapses after the advertising content is sent to the one or more recipient devices and/or otherwise presented to the customer using customer computing device 302.

In some embodiments, one or more events different from those discussed above may be performed if, for instance, the customer computing device 302 that is detected and/or otherwise recognized at banking center 304 by customer assistance computing platform 324 is determined to belong to a person who is not a current customer of the financial institution operating banking center 304. For example, in these instances, customer assistance computing platform 324 may generate and/or send a prompt to customer computing device 302 asking the user of customer computing device 302 to download and/or install a certain application, view certain content (e.g., advertising content about opening an account and/or other information about services that may be available at banking center 304), and/or perform other actions. Additionally or alternatively, one or more events of those discussed above may be repeated for a second customer who may be using a second customer computing device similar to customer computing device 302.

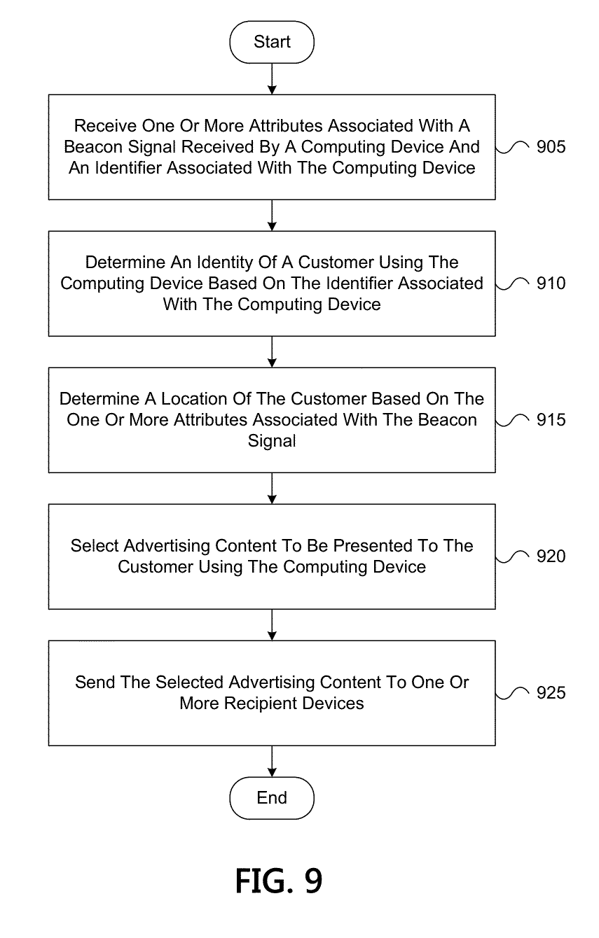

FIG. 9 depicts an illustrative method for providing targeted advertising using local positioning technology in accordance with one or more example embodiments. As seen in FIG. 9, at step 905, a computing platform may receive one or more attributes associated with a beacon signal received by a computing device and an identifier associated with the computing device. At step 910, the computing platform may determine an identity of a customer using the computing device based on the identifier associated with the computing device. At step 915, the computing platform may determine a location of the customer based on the one or more attributes associated with the beacon signal. At step 920, the computing platform may select advertising content to be presented to the customer using the computing device based on the identity of the customer using the computing device and/or based on the location of the customer using the computing device. At step 925, the computing platform may send the selected advertising content to one or more recipient devices.

As illustrated above, systems and methods for providing enhanced retail customer experiences using indoor positioning technology are presented. In one or more example embodiments, a user may be identified based on a detection of a personal device of the user at a particular location, such as a banking center. After the user is identified, a notification that includes targeted advertising content may be presented on the user's personal device. The targeted advertising content included in the notification may be generated and/or selected based on the identity of the user and the detected location of the user's personal device within the banking center. In some instances, the subject of the targeted advertising content may be a product offered by the financial institution operating the banking center.

In some instances, the user's personal device may be detected using indoor positioning system technology. After the notification that includes the targeted advertising content is presented, data associated with the user may be evaluated to determine an effectiveness level of the targeted advertising content. For example, data indicating whether the user subsequently purchased a product being advertised in the targeted advertising content may be evaluated after a predetermined amount of time elapses to determine the effectiveness level of the targeted advertising content. In some instances, the targeted advertising content included in the notification may be selected based on learned experience data that is specific to the user. The targeted advertising content may additionally or alternatively be presented on at least one display screen that is near the detected location of the user's personal device. For instance, the advertising content may be displayed on a wall display or on another device, such as a tablet computer, that may be available on a counter at the banking center for customer use. For example, targeted advertising content for the user may be displayed on a wall-mounted display screen showing mortgage rates, based on a determination that the user is standing near and/or otherwise located within a predetermined distance of the wall-mounted display screen.

In some instances, banking and/or financial data may be used in selecting the advertising content to be presented to the user. For example, search history and/or web history information regarding the user's previous interaction with banking website (e.g., the user's search for information about a 529 savings plan), transaction history information (e.g., the user's completion of a flurry of transactions at a baby clothing store), demographic information (e.g., the age of the customer may imply that the flurry of transactions at the baby clothing store is for a new grandchild), and/or other information may be used in selecting the advertising content to be presented to the user. Additionally or alternatively, activity across any and/or all channels (e.g., online banking, mobile banking, and/or the like) may be taken into account in selecting advertising content. Additionally or alternatively, the advertising content that is presented may be the financial institution's own advertising content or may be third-party advertising content.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A method, comprising:
at a customer assistance computing platform comprising at least one processor, memory, and a communication interface:
receiving, by the at least one processor, via the communication interface, from a customer computing device, one or more attributes associated with a beacon signal received by the customer computing device and an identifier associated with the customer computing device;
determining, by the at least one processor, an identity of a customer using the customer computing device based on the identifier associated with the customer computing device;
determining, by the at least one processor, a location of the customer using the customer computing device based on the one or more attributes associated with the beacon signal received by the customer computing device;
selecting, by the at least one processor, based on the identity of the customer using the customer computing device and based on the location of the customer using the customer computing device, advertising content to be presented to the customer using the customer computing device; and
sending, by the at least one processor, via the communication interface, to one or more recipient computing devices, the selected advertising content.

2. The method of claim 1, wherein the beacon signal received by the customer computing device is associated with at least one beacon deployed at a banking center.

3. The method of claim 2, wherein the one or more attributes associated with the beacon signal received by the customer computing device include a unique identifier associated with the at least one beacon deployed at the banking center.

4. The method of claim 3, wherein the identifier associated with the customer computing device includes user account information associated with a mobile banking application on the customer computing device.

5. The method of claim 4, further comprising:
receiving, by the at least one processor, via the communication interface, from the customer computing device, biometric input information captured by the mobile banking application on the customer computing device.

6. The method of claim 5, wherein determining the identity of the customer using the customer computing device includes confirming the identity of the customer using the customer computing device based on the biometric input information captured by the mobile banking application on the customer computing device.

7. The method of claim 3, wherein determining the location of the customer using the customer computing device includes accessing beacon deployment information that maps identifiers for a plurality of beacons to corresponding deployment locations of the plurality of beacons.

8. The method of claim 7, wherein determining the location of the customer using the customer computing device includes determining that the customer using the customer computing device is located in a specific area of the banking center.

9. The method of claim 2, wherein the advertising content to be presented to the customer using the customer computing device is selected based on customer-specific learned experience data.

10. The method of claim 2, wherein the advertising content to be presented to the customer using the customer computing device is selected based on web history information.

11. The method of claim 2, wherein the advertising content to be presented to the customer using the customer computing device is selected based on transaction history information.

12. The method of claim 2, wherein the advertising content to be presented to the customer using the customer computing device is selected based on customer demographic information.

13. The method of claim 2, wherein the advertising content to be presented to the customer using the customer computing device is selected based on multi-channel activity information.

14. The method of claim 2, further comprising:
prior to sending the selected advertising content to the one or more recipient computing devices, selecting, by the at least one processor, the one or more recipient computing devices from one or more potential recipient computing devices based on the identity of the customer using the customer computing device and based on the location of the customer using the customer computing device.

15. The method of claim 2, wherein the one or more recipient computing devices include the customer computing device.

16. The method of claim 2, wherein the one or more recipient computing devices include a wall display device at the banking center.

17. The method of claim 2, wherein the one or more recipient computing devices include a public device at the banking center.

18. The method of claim 2, further comprising:
updating, by the at least one processor, customer history data associated with the customer using the customer computing device,
wherein updating the customer history data associated with the customer using the customer computing device includes determining an effectiveness level of the selected advertising content sent to the one or more recipient computing devices.

19. A system, comprising:
at least one processor;
a communication interface communicatively coupled to the at least one processor; and
memory storing computer-readable instructions that, when executed by the at least one processor, cause the system to:
receive, via the communication interface, from a customer computing device, one or more attributes associated with a beacon signal received by the customer computing device and an identifier associated with the customer computing device;
determine an identity of a customer using the customer computing device based on the identifier associated with the customer computing device;
determine a location of the customer using the customer computing device based on the one or more attributes associated with the beacon signal received by the customer computing device;
select, based on the identity of the customer using the customer computing device and based on the location of the customer using the customer computing device, advertising content to be presented to the customer using the customer computing device; and
send, via the communication interface, to one or more recipient computing devices, the selected advertising content.

20. One or more non-transitory computer-readable media storing instructions that, when executed by a computing device comprising at least one processor, memory, and a communication interface, cause the computing device to:
receive, via the communication interface, from a customer computing device, one or more attributes associated with a beacon signal received by the customer computing device and an identifier associated with the customer computing device;
determine an identity of a customer using the customer computing device based on the identifier associated with the customer computing device;
determine a location of the customer using the customer computing device based on the one or more attributes associated with the beacon signal received by the customer computing device;
select, based on the identity of the customer using the customer computing device and based on the location of the customer using the customer computing device, advertising content to be presented to the customer using the customer computing device; and
send, via the communication interface, to one or more recipient computing devices, the selected advertising content.
